(19) United States
(12) Patent Application Publication
(10) Pub. No.: US 2002/0099656 A1
(43) Pub. Date: Jul. 25, 2002

(54) Electronic funds transfer system for processing multiple currency transactions

(76) Inventor: Kenneth Tien Poh Wong, Singapore (SG)

Correspondence Address: JENKENS & GILCHRIST, 3200 Fountain Place, 1445 Ross Avenue, Dallas, TX, 75202-2799, US

(21) Appl. No.: 10/005,539

(22) Filed: Nov. 13, 2001

(30) Foreign Application Priority Data
Nov. 14, 2000 (SG) 200006605-0

(51) Int. Cl. G06F 17/60

(52) U.S. Cl. 705/40; 705/39; 705/42

(57) ABSTRACT

Methods of processing electronic transfers of funds from a payer account held at a payer financial institution to a financial settlement network in a currency that may be the same as or different from the funds in the payer account, and transfers from the financial settlement network to a payee account in a currency that, again, may be the same as or different from the funds in the payee account. The transfers are initiated by payment instructions transmitted by the payer to a payment gateway that provides mappings between the payer account and at least one credit card account in a currency nominated from those currencies supported by the payer financial institution for settlement purposes. The payment gateway also provides mappings between a plurality of payment currencies and at least one acquiring account held by a payee in a currency supported by an acquiring financial institution. Foreign exchange conversions involved in the transfers may be effected by the financial institutions, by the financial settlement network, or both as required. The methods optionally provide for transfers to financial institutions that are not members of the financial settlement network by providing agent financial institutions to integrate subsidiary national clearing networks.

### RELATED APPLICATION

The present application is related to Singapore Patent Application No. 200004310-9 filed on Jul. 31, 2000 by the present applicant and entitled “An electronic funds transfer system using credit card settlement and financial network infrastructure”, the disclosure of which is incorporated herein by reference. The specification of application No. 200004310-9 will be hereinafter referred to as “the earlier specification”.

### BACKGROUND OF THE INVENTION

(i) Field of the Invention

This invention relates to an electronic payment transfer system that facilitates integration with existing financial services networks to implement domestic and international funds transfers, be it business to business transfers, business to consumer transfers and vice versa, as well as consumer to consumer transfers. In particular, although not exclusively, the invention relates to a method and apparatus for processing an electronic transfer of funds from one account to another account associated with a financial network, which transfer potentially involves foreign currency exchange.

(ii) Discussion of the Background Art

Existing arrangements for initiating funds transfers involving foreign currency typically require a business or consumer to provide instructions to a financial institution via a branch, either in person or in writing, or directly via financial institution supplied proprietary work stations located in a business's offices. Manual preparation of instructions is slow and inefficient, whilst the cost for both the customer and the financial institution for installation and maintenance of proprietary work stations can be prohibitive. The consumers and businesses encompass parties that wish to trade in goods and services, as well as anyone who may wish to remit funds to another party or, as the context may require, the relevant authorised signatories of those parties.

Currently, when financial institutions make cross border payments on behalf of a paying party (“payer”), that party's payment instruction is typically manually converted by the payer's financial institution into a message that is then sent to the recipient party's (“payee”) financial institution. Such messages must generally be assembled in accordance with a specific protocol, such as for SWIFT, that is recognised by banks and other financial institutions. If the payer's financial institution and the payee's financial institutions do not maintain a relationship with one another, an additional message must also be sent to the payer financial institution's correspondent financial institution.

The SWIFT financial network acts to route messages between member financial institutions, typically banks. Some validation of data is performed, however this validation does not usually include validation of information relating to the transaction, such as the payer account number with the payer's financial institution, as financial networks like SWIFT do not maintain such information. Member financial institutions settle against each other for individual transactions, if correspondent financial institutions are also involved, then multiple settlement “legs” are required. Settlement needs to be performed for each individual transaction, which adds to service costs and possible delays with transmission of finds, particularly where foreign currency exchange is required.

A foreign currency buyer is also exposed to the risk of unfavourable exchange fluctuations when settlement occurs some days after payment is authorised.

### BRIEF SUMMARY OF THE INVENTION

An embodiment in accordance with the present invention provides an apparatus and method for effecting electronic funds transfers which delivers a more rapid and economical method of processing payments involving foreign currency, when compared with traditional foreign exchange and telegraphic transfer arrangements.

Another embodiment in accordance with the invention provides an apparatus and method for effecting electronic funds transfers involving foreign currency which may be implemented quickly and conveniently through integration with existing financial networks, particularly networks and arrangements utilised for credit card settlement purposes.

Another embodiment in accordance with the invention provides an apparatus and method for effecting electronic funds transfers which substantially reduces foreign exchange risks.

Yet, another embodiment in accordance with the invention provides an apparatus and method for effecting electronic funds transfers which allows remote, secure electronic initiation by customers and facilitates on-line tracking and reconciliation of payments.

And, another embodiment in accordance with the invention provides an electronic funds transfer system which ameliorates and more appropriately shares the risks associated with undertaking financial transactions involving foreign currencies via the Internet.

In a first aspect, the invention resides in a method of processing an electronic transfer of funds from a payer account held at a financial institution to a financial settlement network in a currency that may be the same as or different from the finds in the payer account, which transfer is initiated by a payment instruction transmitted by the payer to a payment gateway; said method including the steps of:

(a) providing at the payment gateway, a mapping between the payer account and at least one credit card account in a currency nominated from those currencies supported by the financial institution for settlement purposes;

(b) providing at the financial institution, a foreign exchange bridge for determining internally any foreign exchange rates between payer accounts and the mapped credit card accounts;

(c) the payment instruction transmitted by the payer including a payer account number for debiting purposes, a payment amount and a payment currency code;

(d) the payment gateway selecting, in response to the payment instruction, a credit card account wherein:

(i) if a credit card account having the same currency as the payment currency code is mapped to the payer account number, that mapped credit card account;

(ii) otherwise a credit card account in the same currency as the payer account currency;

(e) the payment gateway creating a payment request message, including the payment amount, payment currency code and the selected credit card account details and passing the payment request message to the financial settlement network; and

(f) the financial settlement network routing the payment request message to the payer financial institution wherein:

(i) if the payment currency code is for a currency not supported by the financial institution, the financial network effects the foreign exchange conversion externally of the financial institution; or

(ii) if the payment currency code is for a currency supported by the financial institution, the financial institution effects any foreign exchange conversion required via the system bridge.

Each payer account may be mapped to respective credit card accounts in the currencies supported for settlement.

In an alternative arrangement, each currency supported by the financial institution may, for example, be mapped directly to a bank identification number (BIN) for settlement purposes.

In a second aspect, the invention resides in a method of processing an electronic transfer of funds from a financial settlement network to a payee account in a currency that may be the same or different from funds in the payee account held at a financial institution, which transfer occurs in response to a payment instruction transmitted to a payment gateway; said method including the steps of:

(a) providing at the payment gateway, a mapping between a plurality of payment currencies and at least one acquiring account in a currency supported by acquiring financial institutions;

(b) providing at each acquiring financial institution, a foreign exchange bridge for determining internally any foreign exchange rates between the mapped acquiring accounts and payee accounts;

(c) the payment instruction including a payment amount, payment currency code and acquiring account details identifying the payee financial institution;

(d) the payment gateway selecting, in response to the payment instruction, an acquiring account wherein:

(i) if an acquiring account for the payee is mapped to a payment currency having the same currency as the payment currency code, that acquiring account; or

(ii) if none of the mapped payment currencies corresponds to the payment currency code, generating an error message;

(e) the payment gateway creating a payment request message, including the payment amount, payment currency code and acquiring account details and passing the payment request message to the financial settlement network; and

(f) the financial settlement network routing the payment request message to the acquiring financial institution holding the acquiring account for the payee, wherein:

(i) if the payment currency code is for a currency not supported by the acquiring financial institution, the financial network effects the foreign exchange conversion externally of the acquiring financial institution; or

(ii) if the payment currency code is for a currency supported by the acquiring financial institution, the acquiring financial institution effects any foreign exchange conversion required via the system bridge.

The acquiring accounts may be held at the payee financial institution. Suitably funds will be transferred internally from the acquiring account to the payee account.

In an alternative arrangement, acquiring accounts may be held at an agent financial institution that is associated with a subsidiary financial network of which the payee financial institution is a member. Suitably funds will be transferred externally from the acquiring account of the agent financial institution to the payee account in accordance with clearing mechanisms of the subsidiary financial network.

Suitably the acquiring accounts mapped by the payment gateway (step (a) above) include accounts held at acquiring financial institutions that are also agent financial institutions, which are agents for payments made in a currency supported by the subsidiary financial network. In this modified method, the selection of the acquiring account by the payment gateway (step (d) above) proceeds as follows:

(i) if the payee account is held at an acquiring financial institution, the acquiring account at the acquiring financial institution mapped to the payment currency is selected;

(ii) else, if the payment currency corresponds to the currency supported by a subsidiary financial network, the acquiring account at the agent financial institution mapped to the payment currency is selected; or

(iii) if none of the mapped payment currencies corresponds to the payment currency, generating an error message.

Preferably, the acquiring account at the agent financial institution is established for the sole purpose of clearing, through the subsidiary financial network, transactions arriving from the financial settlement network.

### BRIEF DESCRIPTION OF THE DRAWINGS

FIG. 1 is an overview diagram showing components of an electronic funds transfer system relating to a preferred embodiment of the invention;

FIG. 2 is a diagram illustrating steps in a first example of a process for transferring funds from a financial institution to a financial settlement network utilising the system of the preferred embodiment;

FIG. 3 is a diagram illustrating steps in a second example of the process for transferring funds utilising the system of the preferred embodiment;

FIG. 4 is a diagram illustrating steps in a third example of the process for transferring funds utilising the system of the preferred embodiment; and

FIG. 5 is diagram illustrating steps in a fourth example of the process for transferring funds utilising the system of a modified embodiment.

FIG. 6 is an overview diagram illustrating the entities involved in a process for transferring funds from a financial settlement network to an acquiring financial institution;

FIG. 7 is a diagram illustrating steps in a first example of the funds transfer process relating to FIG. 6;

FIG. 8 is a diagram illustrating steps in a second example of the funds transfer process relating to FIG. 6;

FIG. 9A is a diagram illustrating steps in a third example of the funds transfer process relating to FIG. 6;

FIG. 9B is a diagram illustrating the steps in a fourth example of the funds transfer process relating to FIG. 6;

FIG. 10 is an overview diagram illustrating the entities involved in a process for transferring funds from a financial settlement network to a payee financial institution, via and agent financial institution.

### DETAILED DESCRIPTION OF THE PREFERRED EXEMPLARY EMBODIMENTS

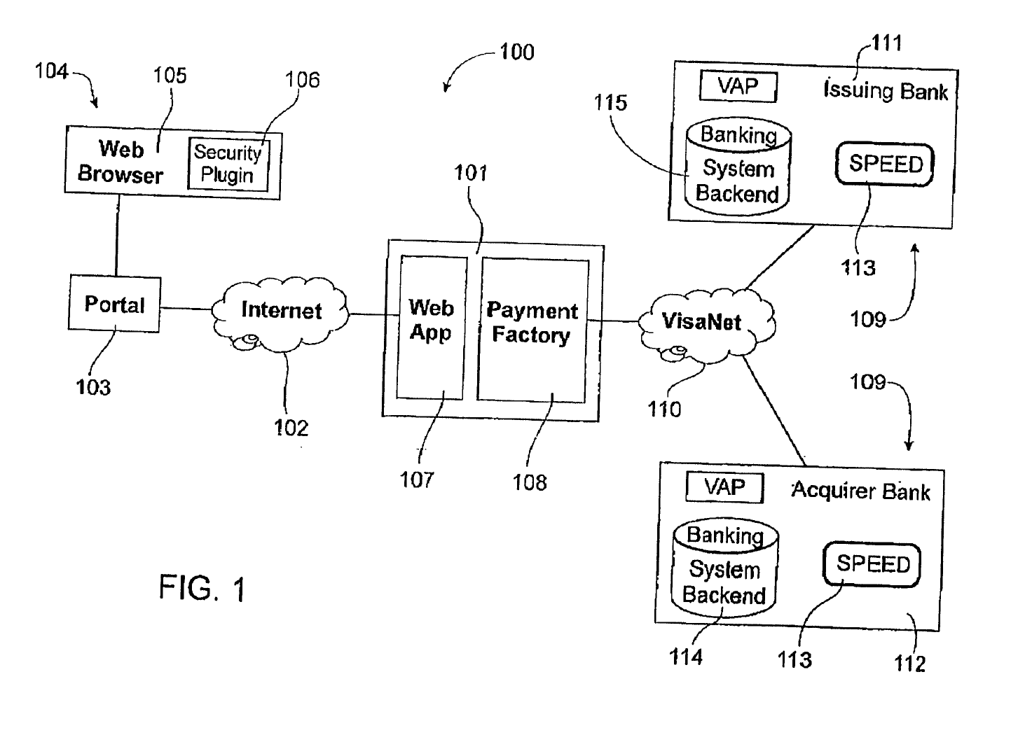

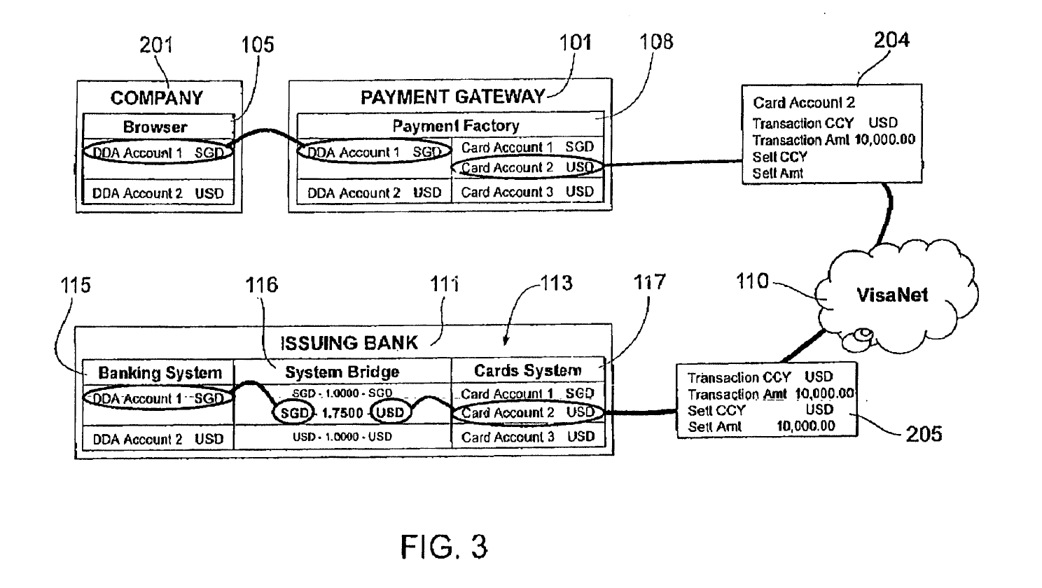

The diagram in FIG. 1 illustrates one example of the entities and components involved in the operations of the electronic funds transfer system 100 relating to the processing methods of the present invention. The diagram is a somewhat simplified version of the apparatus illustrated in FIG. 3 of the earlier specification, and depicts a payment gateway 101 which communicates via the Internet 102 (or other wide area communications network) and business hubs or portals 103 with consumer/business (party) computer systems 104. Such parties can conveniently use a browser application 105 with a security plug-in 106 for this purpose. The payment gateway 101 includes a web application 107 running on a front-end web server for handling user administration, financial institution administration and payment instructions from parties.

The payment gateway 101 also communicates with financial institutions 109 via a financial settlement network 110 (such as VISANET) through a communications interface (not shown). In the diagram, the financial institutions include an issuing bank 111 and an acquirer bank 112, which each include a payment service enhancement package 113. The service package 113 (being for e-payment enhancement deployment or SPEED) is a module which facilitates integration of the finds transfer system 100 with existing financial institution back end systems 114 and 115.

The payment gateway 101 includes a payment factory 108 to process payment instructions received from the web application 107. The payment factory 108 validates incoming payment instructions prior to switching them out to the financial network 110 for approval. A separate switch (not shown, which may be based on the IST/Switch supplied by Oasis Technology Ltd.) effects switching out of payment instructions that are in, for example, the VISA ISO 8583 format in the present embodiment. The payment factory of the present embodiment incorporates a payment engine, built using Oasis's IST/Foundation component based application framework software which supports a range of financial, Internet customer-merchant, and EDI based transactions, to effect processing of funds transfers.

The interactions between the entities and components of the system 100 involved in the funds transfers will now be described in relation to several examples wherein the party computer system 104 is notionally that of a payer company 201. The company holds funds at a payer financial institution, the issuing bank 111, which is a member of the VISANET financial settlement network 110. In the examples, the company holds two demand deposit accounts (DDA) with the issuing bank, Account 1 in Singapore dollars (SGD) and Account 2 in United States dollars (USD). These two payer accounts are set up with the payment gateway 108 in the manner described in the earlier specification.

Reference is also made to an exemplary payee financial institution, namely acquirer bank 112 that is also a member of VISANET network 110, to which finds happen to be transferred in the examples. The payee financial institution holds the accounts for the payee entities. Where payee entities hold accounts at financial institutions which are not members of the financial settlement network, an agent financial institution with a link to the financial network can be establish as described below.

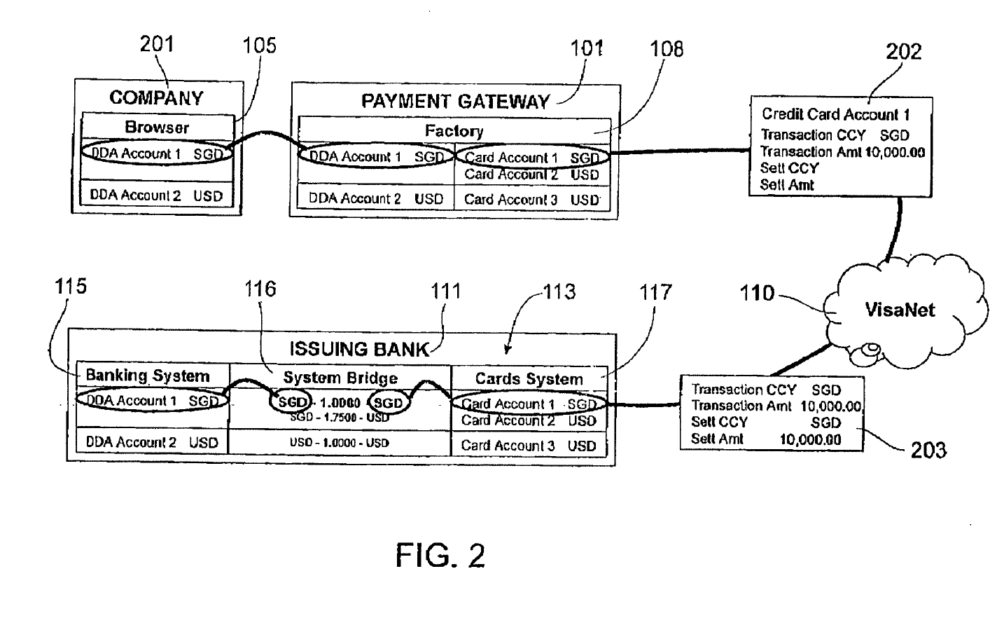

The first example of the processing method is depicted in FIG. 2 of the accompanying drawings wherein the company 201 is able to nominate either DDA Account 1 or DDA Account 2 presented by the web application 107 via the web browser 105. Payer banks, such as issuing bank 111, have the option of defining those currencies in which they are prepared to settle, allowing them to earn currency exchange fees for those defined. Accordingly the payer banks need to maintain settlement accounts in each of the defined settlement currencies. Funds transfer transactions involving other currencies permit the financial settlement network to earn foreign exchange fees, as will be apparent from the third example.

In setting up its customers, payer banks can map multiple credit card accounts in respective settlement currencies to each payer account. The company 201, as shown in FIG. 2, has DDA Account 1 mapped to Card Account 1 held in SGD and to Card Account 2 held in USD. Whilst DDA Account 2 is mapped to Card Account 3 also held in USD. These mappings are reflected in the details of the respective accounts registered with the payment gateway 101. Currency codes are employed to conveniently denote the particular currency.

When a payer, such as company 201, issues a payment instruction to the payment gateway 101 via the browser 105, the instruction nominates a payer account for debiting purposes, DDA Account 1 in the example, together with the payment currency code and amount, here SGD 10,000. In response to the instruction, the payment factory 108 in the gateway selects a mapped credit card account according to the payer account and the payment currency nominated by the payer. In the event that none of the credit card accounts mapped to the payer account were held in the payment currency, the credit card account in the same currency as that of the payer account would be selected. If the payer account was not identified by the payment factory at all, an error message could be generated.

Thus in the first example, Card Account 1 in SGD is selected and a payment request message 202, containing these details and the payment amount is created by the payment factory 108. The payment request message is then passed to the financial settlement network 110 using the appropriate message protocols for the network in order to route the message to the payer financial institution, in the example issuing bank 111. The payment request message also includes the acquiring BIN, which is usually embedded in the payee account number.

The payer financial institution includes, as a component of the service enhancement package SPEED 113, a system bridge 116 between its banking system backend 115 and credit card system 117 interfaced to the financial settlement network VISANET 110. The system bridge 116 provides a link between the mapped credit card accounts in the cards system which effects any foreign exchange conversions between differing currencies, if supported. The system bridge may be developed internally by the payer financial institution or may be in the form of software/hardware provided by a third party systems integrator. The system bridge 116 formats messages from the financial settlement network 110 into a format readable by the payer financial institution's backend banking system 115. This arrangement allows the balance of payer accounts to be checked for available finds prior to authorising the transfer, and possibly allowing a hold to be put on the finds pending the transaction.

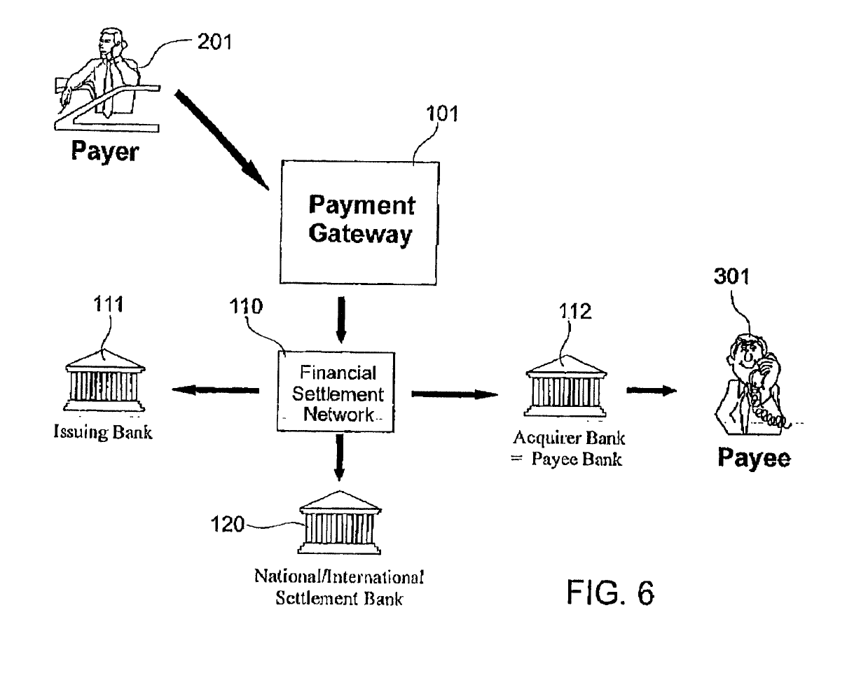

In the present example the payment currency is SGD, accordingly the system bridge mapping between Card Account 1 (SGD) and the company's DDA Account 1 (SGD) is unity. Thus no foreign exchange is required in this example, and a payment authorisation 203 is returned to the financial settlement network by issuing bank 111. The financial settlement network takes the authorisation and, based on the acquiring BIN contained in the authorisation, determines the settlement currency and amount for the funds transfer is also SGD 10,000. The financial settlement network 110 maintains a mapping of acquiring BINs and settlement currencies, as will be described in more detail in relation to FIGS. 6 to 10. Thus the financial settlement network, for example VISANET, need not provide any currency exchange for the funds transfer, although this capability is desired as will be apparent from the second example discussed below.

In the second example illustrated in FIG. 3, the currency and amount of the funds transfer desired by the company 201 is USD 10,000, and a payment instruction including these details transmitted to the payment gateway 101. The payment factory 108 receives the instruction identifying payer account DDA Account 1 over the Internet 102 through the web application 105. The payment factory then selects from a table of account mappings, in response to the payment instruction, a credit card account mapped to DDA Account 1 which is held in USD, namely Card Account 2. The selection of a mapped credit card account is made by the same method described above.

The payment factory then creates a payment message 204 including the payment currency, amount and details of the selected credit card account—ie. Card Account 2: USD 10,000—which message is passed to the financial settlement network 110. The payment message 204 is then routed to the payer financial institution, issuing bank 111 by the financial settlement network.

Upon receipt of the payment message 204, the issuing bank 111 identifies, using its internal banking system 115, that the payer account (DDA Account 1) mapped to Card Account 2, is in SGD. Thus the issuing bank is then aware that a foreign exchange conversion is required. The system bridge 116 provides for a foreign exchange rate of 1.750 between USD and SGD and, accordingly the company's DDA Account 1 will be debited SGD 17,500. In this example the issuing bank 111 has defined USD as one of the settlement currencies available for funds transfer purposes. Provided sufficient funds are present in DDA Account 1, a payment authorisation message 205 is returned to the financial settlement network 110. If there are insufficient finds in the payer account, a payment declined message will be returned to the financial settlement network. In this example the settlement currency and amount are USD 10,000, respectively.

Because the transaction is in USD throughout, as far as the financial settlement network is concerned, no foreign exchange fees are applied by the network. Accordingly, the issuing bank is able to earn internally foreign currency exchange fees for settlement made in a defined currency of USD from the payer account in SGD. The exchange fees are suitably built into the exchange or board rate programmed into the system bridge 116.

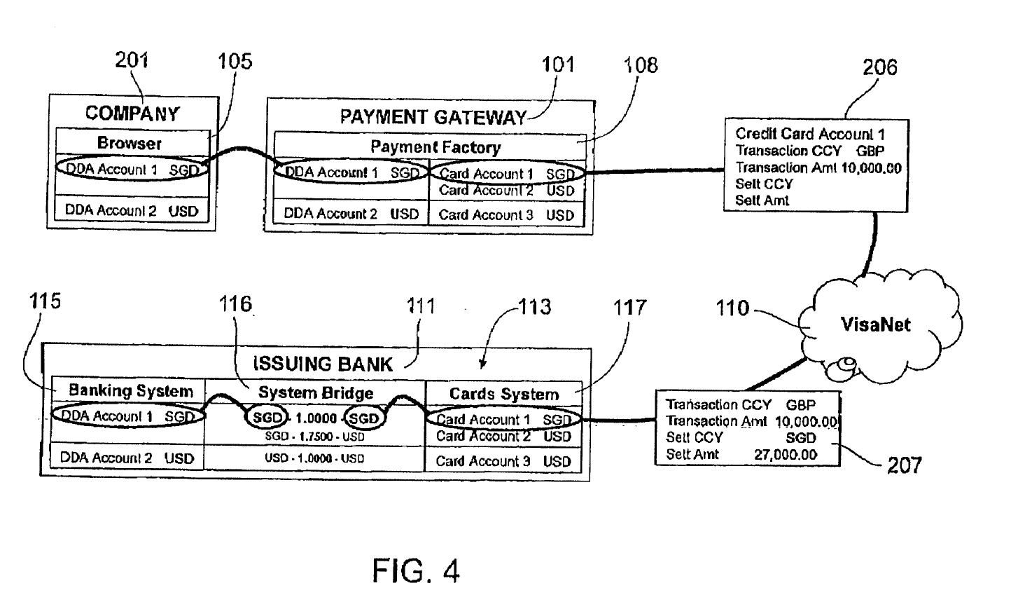

Turning to FIG. 4, which illustrates a third example of the funds transfer process of the embodiment, the company 201 instructs the payment gateway 101 that a payment of 10,000 British pounds (GBP) is to be made from DDA Account 1. Upon receipt of the payment instruction, the payment factory 108 selects Card Account 1 since there are no card accounts held in GBP that are mapped to DDA Account 1. Card Account 1 being in the same currency (SGD) as the payer account is selected in order to minimise multiple foreign exchange legs in the funds transfer process.

The payment gateway 101 then creates a payment request message 206 identifying Card Account 1 and GBP 10,000 as payment currency and amount. The message is then passed to the financial settlement network 110, for example VISANET, for routing to the payer financial institution, issuing bank 111. As GBP is not supported by the issuing bank 111 in the example, the system bridge 116 again uses a unity exchange rate between Card Account 1 and DDA Account 1, both in SGD. The settlement currency is generated by the financial settlement network 110, based on a further mapping (not shown) that it maintains. The financial settlement network maps credit card account number ranges to settlement currencies for payer financial institutions, such as the issuing bank 111. The conversion between transaction currency (GBP in the example) and settlement currency (SGD in the example) is performed by the financial settlement network 110, for example VISANET, at its prevailing foreign exchange rates.

In this third example, foreign exchange fees may thus be earned by the financial settlement network, as the exchange is effected externally of the payer financial institution. Suitably the payer company 210 would be alerted that, since the payment is in a currency not supported by their bank, additional fees for foreign exchange may be levied by the financial settlement network 110. When the financial settlement network handles the foreign exchange, its fees will be included in the foreign exchange rate quoted.

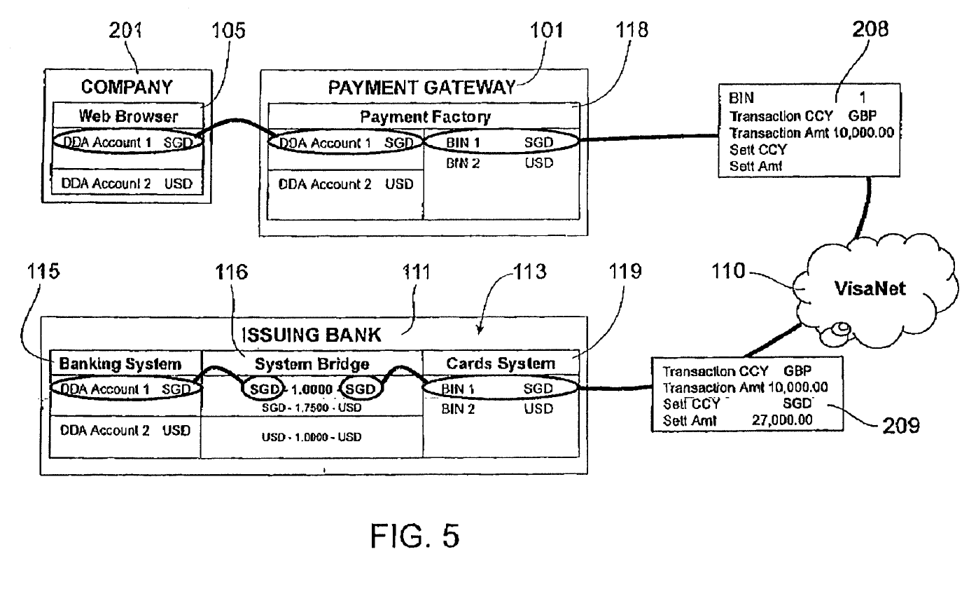

A fourth example of the process is shown in FIG. 5 which relates to a modified embodiment of the processing method of the invention. The modification relates to the nature of the account mappings maintained in each of the payment factory 118 and in the cards system 119 side of system bridge 113. Rather than mapping each payer account to at least one credit card account in a currency supported by the payer financial institution (as for the above examples), all of the payers accounts are mapped to a bank identification number (BIN) which supports each currency.

In the fourth example, the company 201 has two payer accounts as before, DDA Account 1 in SGD and DDA Account 2 in USD, but these are both now mapped to payer bank BINs. BIN 1 for SGD and BIN 2 for USD which are the respective settlement avenues for settlement by issuing bank 111. Accordingly, the payment message 208 generated by payment factory in response to a payment instruction for a transfer of GBP 10,000 out of DDA Account 1, will contain BIN 1 together with the amount and currency of the transfer. It will be recalled that, where the payer financial institution does not support settlement in a currency (GBP here), the currency selected will mirror that of the payer account (ie. SGD).

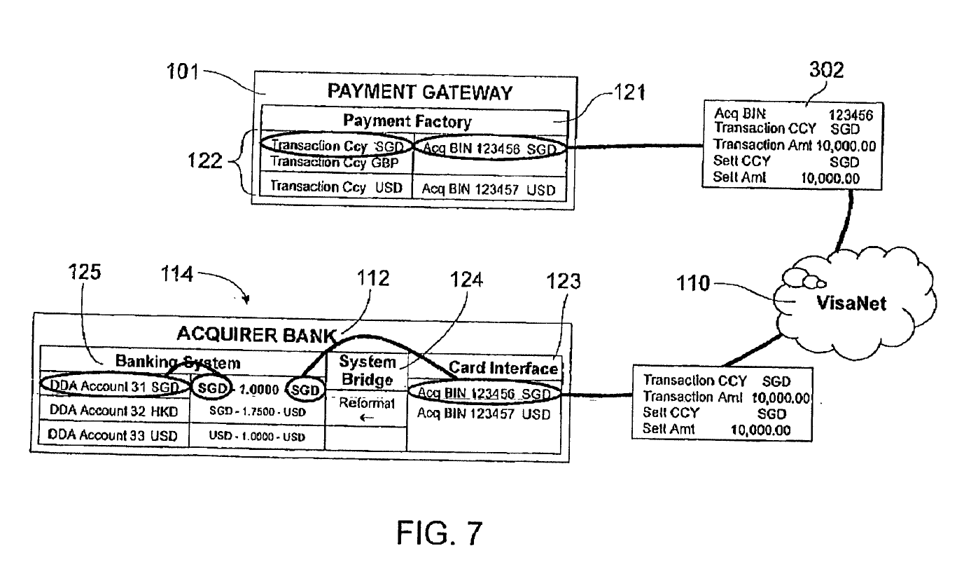

A second aspect of the present invention relates to the processes conducted by the funds transfer system 100 in crediting payee accounts. Examples of these processes are discussed in relation to FIGS. 7 to 9. This involves the payment gateway 101 of the embodiment effecting transfer of funds to a payee account held at a payee financial institution, pursuant to receipt of a payment authorisation message by the financial settlement network 110. Whilst the diagram illustrated in FIG. 1 remains a pertinent example of components of the system, a clearer appreciation of the entities involved may be gained from reviewing FIG. 6.

The diagram in FIG. 6 shows a payer, namely corporation 201, and the issuing bank 111 which holds the payer accounts (DDA Account 1 and DDA Account 2) from which funds are transferred in the above examples. Now introduced is a payee, sole trader 301 in the example, who holds payee accounts at a financial institution, acquirer bank 112. The sole trader is the recipient of the funds transfers for the purposes of the following examples. In these examples acquirer bank also happens to be a member of the financial settlement network, VISANET 110.

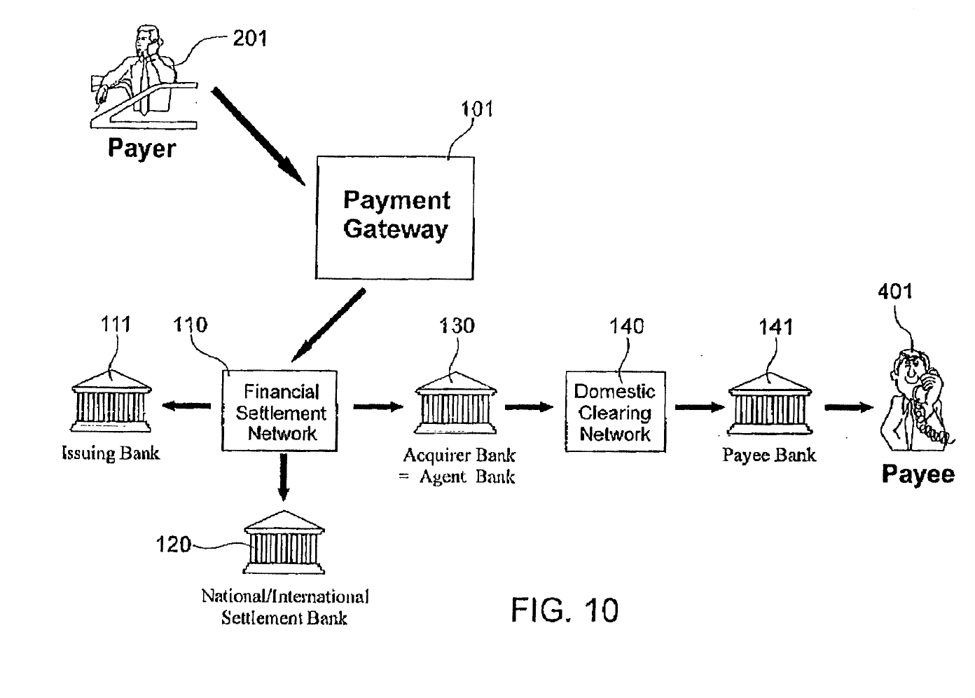

A further financial institution in the form of national/international settlement bank 120 is also a part of the financial settlement network 110. The function of the settlement bank 120 will be described later. It should be noted that the process of the invention is also effective in the case where the payee accounts also happen to be held at the same financial institution which holds the payer accounts. Furthermore an agent bank arrangement allows for payee accounts that are held at a financial institution that is not a member of the financial settlement network. The agent bank arrangement is described later in relation to FIG. 10.

Turning to FIG. 7, there is shown a representation of steps in the embodiment of the second aspect of the electronic funds transfer method of the invention. The steps correspond to the scenario in the first example described above in relation to FIG. 2. It will be recalled, that a finds transfer involving SGD 10,000 was the subject of a payment authorisation 203, which authorisation was received by the financial settlement network 110 from the issuing bank 111. The payment factory 121 within payment gateway 101 further includes, for acquirer financial institutions, mappings 122 between potential transaction currencies and at least one acquiring account in currencies accepted by the financial institutions. Each acquirer financial institution participating in the funds transfer system 100 is set up in the payment factory 121 in this way.

In the examples, the mappings for acquirer bank 112 include the transaction currencies of SGD and GBP both being mapped to Acquiring BIN 123456 held in SGD, whilst the transaction currency of USD is mapped to Acquiring BIN 234567 held in USD. Generally, the payment gateway 101 selects the acquiring account for the acquirer financial institution that is mapped to the same currency as the transaction currency. If no acquiring accounts are mapped to a transaction currency, the payment gateway 101 generates an error message.

Thus, in response to a payment instruction for SGD 10,000 for acquirer bank 112, Acquiring BIN 123456 will be selected by the payment gateway as the acquiring account for the transaction. A payment request message 302, including the payment amount (10,000), the payment or transaction currency code (SGD) and acquiring account details (123456), is passed to the financial settlement network, VISANET 110 in the example. Since Acquiring BIN 123456 is held in SGD, the settlement currency code in the payment request is also set to SGD. The financial settlement network then routes the payment request message 302 to the relevant acquiring financial institution, acquiring bank 112.

The acquirer bank 112 includes a card system interface 123 that receives messages from the financial settlement network 110. A system bridge 124 is also provided between the card system interface 123 and the internal banking system 125 of the acquirer bank 112. The banking system manages the payee accounts, including (for the sole trader 301 of the examples) DDA Account 31 in SGD, DDA Account 32 in Hong Kong dollars (HKD) and DDA Account 33 in USD.

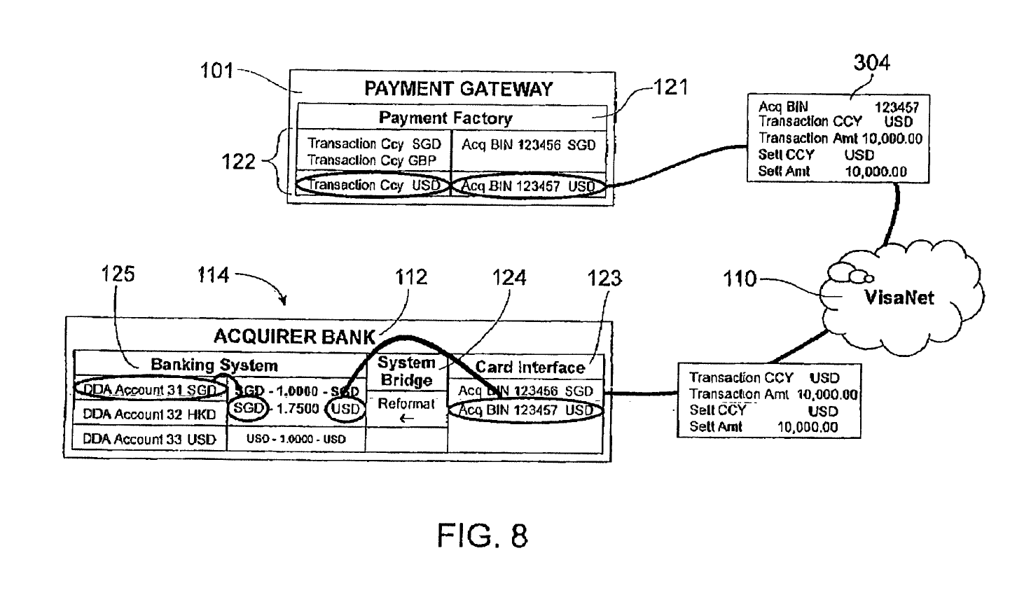

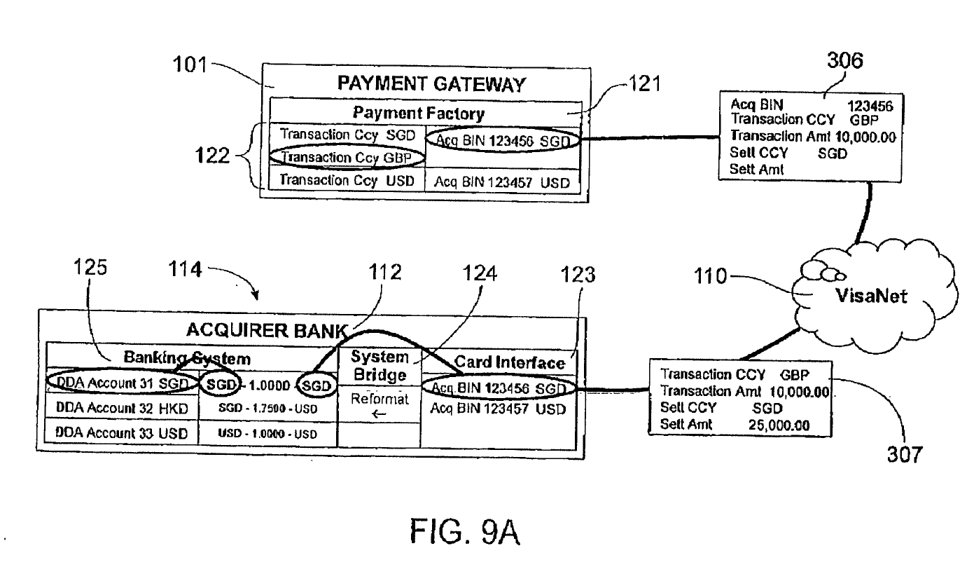

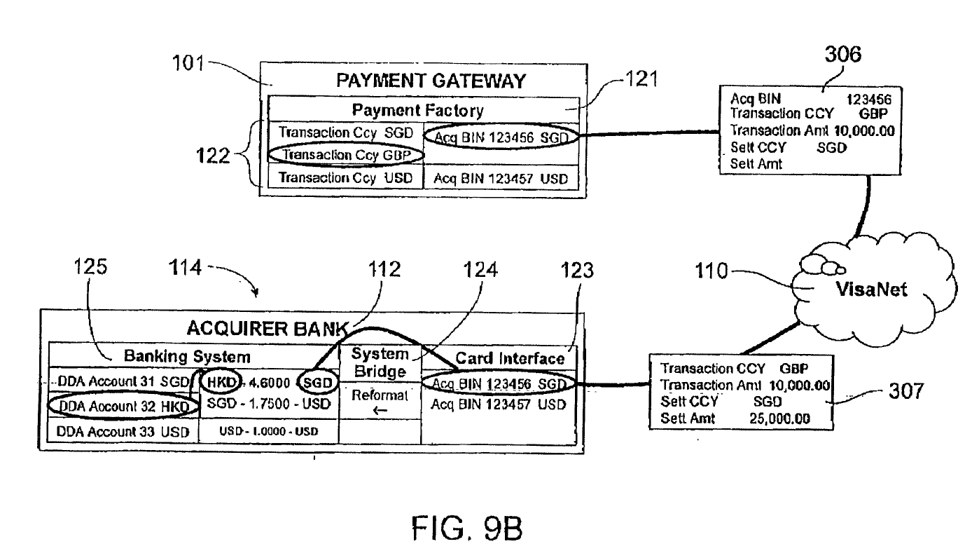

Upon receipt of the payment request message 302, the acquirer bank 112 checks the payment currency code for settlement and finds SGD. In general, if the payment currency code is for a currency that is supported by the acquiring financial institution, that institution effects any foreign exchange conversion which might be required via a system bridge; such as system bridge 124 for acquirer bank 112 in the examples (see FIG. 8 below). However, if the payment currency code is for a currency that is not supported by the acquirer financial institution, the financial network will effect the foreign exchange conversion externally of the acquiring financial institution (see FIG. 9) below.

In the present example however, the banking system 125 of the acquirer bank 112 identifies that the relevant payee account, DDA Account 31, is also held in SGD. Thus no foreign exchange conversion is required and funds may be credited directly to DDA Account 31. If conversion is required, the crediting of funds may involve the national/international settlement bank 120.

The second example illustrated in FIG. 8, the transaction currency code is USD indicated by the payment instruction authorised for USD 10,000. Thus the acquiring account, identified as Acquiring BIN 123457, that is mapped to USD is selected by the payment factory 121. As Acquiring BIN 123457 is held in USD, the settlement currency included in the payment request message 304 is also USD.

The financial settlement network 110 then routes the payment request message 304 to the appropriate acquiring financial institution as determined from the BIN, again acquirer bank 112. The system bridge 124 between the card system interface 123 and the banking system 125 detects that currency conversion is required between the relevant payee account, DDA Account 31 in SGD, and the Acquiring BIN 123457 in USD. As USD is a currency supported by acquirer bank 112 and foreign exchange is involved in the payment, the acquiring financial institution will be required to perform the foreign exchange conversion between the payee account currency (SGD) and the acquiring BIN currency (USD). In this second example the exchange rate has been set at 1.75, which is the acquirer bank's board rate. Thus SGD 17,500 will be credited to DDA Account 31.

Turning to FIG. 9A, there is illustrated steps in a third example of a method embodying the second aspect of the invention, wherein foreign currency conversion is effected externally of financial institutions by the financial settlement network 110. The payment instruction authorises a payment in a currency of GBP, which the payment factory 121 has a mapping to Acquiring BIN 123456. Thus a payment request message 306 is created by the payment gateway 101. The message includes the acquiring account details, together with the transaction currency code and amount of GBP 10,000, and the settlement currency of SGD.

Upon the payment request message being passed to the financial settlement network, it recognizes that a foreign currency conversion between GBP and SGD is required. The amount required for the settlement, SGD 25,000 in the example, is determined by the financial settlement network 110 on the basis of a separate mapping that it maintains. The rate for the conversion is determined on the basis of the locality of the acquiring bank, which may be determined from the BIN. This converted amount is then inserted in an augmented payment request message 307 during routing to the acquiring financial institution, acquirer bank 112. The internal processing of the payment request message upon receipt by the card system interface 123, proceeds via the system bridge 124 to the banking system 125 as in the first example. The foreign currency conversion having been handled externally by the financial settlement network 110, DDA Account 31 is to be then credited with SGD 25,000.

FIG. 9B shows a fourth example wherein both the financial settlement network 110 and the acquiring financial institution effect foreign currency conversion. In this example, the payee, sole trader 301, has instructed his bank that certain payments made in SGD are to be converted to HKD. Accordingly, the system bridge 124 applies a conversion rate of 4.6 to the SGD 25,000 settlement amount, resulting in a credit of HKD 115,000 to DDA Account 32.

The preceding examples dealt with the case of the acquiring accounts were held at a financial institution that is a member of the financial settlement network. In other words the payee financial institution was also an acquiring financial institution. However, in some regions or countries financial institutions may not be individually served by the financial settlement network, for example VISANET. In this case, the finds transfer system of the invention provides for acquiring accounts to be held at an agent financial institution. This arrangement is depicted in FIG. 10, which may be contrasted with FIG. 6. In FIG. 10 payee 401 holds an account at payee bank 141, a financial institution that is not a member of the financial settlement network 110.

Payments to be settled with payee 401 are routed to agent bank 130, which happens to be the only bank in the region which is a member of the financial settlement network 110. The agent bank is also part of the domestic clearing network 140 of which payee bank 141 is a member. The agent bank 130 is nominated to provide the service of clearing with the domestic clearing network 140, transactions arriving from the financial settlement network. A special acquiring account is established at the agent bank for the sole purpose of processing such transactions and clearing them through the domestic network. Accordingly the agent bank receives the payment instructions for domestic financial institutions, reformatting them and routing as appropriate to the domestic network 140. In some instances the domestic clearing network 140 will only handle certain currencies, typically including the domestic currency. This arrangement of at least one agent bank 130 allows the funds transfer system of the invention to make payments to all financial institutions that are members of the domestic clearing network.

It is also possible for some financial institutions to act as both acquiring financial institutions and agent financial institutions. This circumstance may be provided for in the account mappings for such financial institutions, as follows. Acquiring banks all have a unique Bank ID within the financial settlement network of the embodiment. If the payee bank 141 identified in the payment instruction is not an acquiring bank, then the agent bank 130 for the domestic clearing network 140 needs to be selected by the payment gateway 101. This involves checking whether the transaction currency selected is a valid transaction currency that can be handled by the agent bank 130. If the currency selected is not valid, then an error message is generated, otherwise the agent bank for the domestic clearing network (generally one per country) is selected by the payment gateway.

Although illustrative embodiments of the present invention, and various modifications thereof, have been described in detail herein with reference to the accompanying drawings, it is to be understood that the invention is not limited to these precise embodiments and the described modifications, and that various changes and further modifications may be effected therein by one skilled in the art without departing from the scope or spirit of the invention as defined in the appended claims.

1. A method of processing an electronic transfer of funds from a payer account held at a payer financial institution via a financial settlement network to a payee account in a currency that may be the same as or different from the funds in the payer account, which transfer is initiated by a payment instruction transmitted by the payer to a payment gateway associated with the financial settlement network; said method including the steps of:
(a) providing at the payment gateway, a mapping between the payer account and at least one credit card account in a currency nominated from those currencies supported by the payer financial institution for settlement purposes;
(b) providing at the payer financial institution, a foreign exchange bridge for determining internally any foreign exchange rates between payer accounts and the mapped credit card accounts;
(c) the payment instruction transmitted by the payer including a payer account number for debiting purposes, a payment amount and a payment currency code;
(d) the payment gateway selecting, in response to the payment instruction, a credit card account wherein:
(i) if a credit card account having the same currency as the payment currency code is mapped to the payer account number, that mapped credit card account;
(ii) otherwise a credit card account in the same currency as the payer account currency;
(e) the payment gateway creating a payment request message, including the payment amount, payment currency code and the selected credit card account details and passing the payment request message to the financial settlement network; and
(f) the financial settlement network routing the payment request message to the payer financial institution wherein:
(i) if the payment currency code is for a currency not supported by the payer financial institution, the financial network effects the foreign exchange conversion externally of the payer financial institution; or
(ii) if the payment currency code is for a currency supported by the payer financial institution, the payer financial institution effects any foreign exchange conversion required via the system bridge.

2. The method of claim 1 wherein each payer account is mapped to respective credit card accounts in the currencies supported for settlement.

3. The method of claim 1 wherein each currency supported by the payer financial institution may be mapped directly to a bank identification number (BIN) for settlement purposes.

4. The method of claim 1 wherein the foreign exchange bridge initiates return of a payment authorisation message to the financial settlement network, which authorisation message includes a currency code and amount for settlement of the funds transfer.

5. The method of claim 1 wherein, upon the payer financial institution ascertaining that there are sufficient funds in the payer account to effect the transfer, the payer financial institution returns a payment authorisation to the financial settlement network.

6. The method of claim 5 wherein the payment authorisation includes a settlement currency code and settlement amount.

7. The method of claim 1 wherein, upon the payer financial institution ascertaining that there are insufficient funds in the payer account to effect the transfer, the payer financial institution returns a payment decline to the financial settlement network.

8. The method of claim 1 wherein in step (f)(i), the financial settlement network calculates foreign exchange between settlement currency and the currency of funds in the payer account.

9. The method of claim 1 wherein in step (f)(ii), the system bridge calculates foreign exchange between settlement currency and the currency of funds in the payer account.

10. A method of processing an electronic transfer of funds, from a payer account via a financial settlement network to a payee account held at a payee financial institution in a currency that may be the same or different from finds in the payer account, which transfer occurs in response to a payment instruction transmitted by the payer to a payment gateway associated with the financial settlement network; said method including the steps of:
(a) providing at the payment gateway, a mapping between a plurality of payment currencies and at least one acquiring account in a currency supported by acquiring financial institutions;
(b) providing at each acquiring financial institution, a foreign exchange bridge for determining internally any foreign exchange rates between the mapped acquiring accounts and payee accounts;
(c) the payment instruction including a payment amount, payment currency code and acquiring account details identifying the payee financial institution;
(d) the payment gateway selecting, in response to the payment instruction, an acquiring account wherein:
(i) if an acquiring account for the payee is mapped to a payment currency having the same currency as the payment currency code, that acquiring account; or
(ii) if none of the mapped payment currencies corresponds to the payment currency code, generating an error message;
(e) the payment gateway creating a payment request message, including the payment amount, payment currency code and acquiring account details and passing the payment request message to the financial settlement network; and
(f) the financial settlement network routing the payment request message to the acquiring financial institution holding the acquiring account for the payee, wherein:
(i) if the payment currency code is for a currency not supported by the acquiring financial institution, the financial network effects the foreign exchange conversion externally of the acquiring financial institution; or
(ii) if the payment currency code is for a currency supported by the acquiring financial institution, the acquiring financial institution effects any foreign exchange conversion required via the system bridge.

11. The method of claim 10 wherein acquiring accounts are held at the payee financial institution.

12. The method of claim 11 wherein funds are transferred internally from the acquiring account to the payee account.

13. The method of claim 10 wherein acquiring accounts are held at an agent financial institution that is linked to a subsidiary financial network of which the payee financial institution is a member.

14. The method of claim 13 wherein finds are transferred externally from the acquiring account to the payee account in accordance with clearing mechanisms of the subsidiary financial network.

15. The method of claim 13 wherein the acquiring accounts mapped at step (a) include accounts held at acquiring financial institutions that are also agent financial institutions, which are agents for payments made in a currency supported by the subsidiary financial network.

16. The method of claim 15 wherein the selection of the acquiring account at step (d) instead proceeds as follows:
(i) if the payee account is held at an acquiring financial institution, the acquiring account at the acquiring financial institution mapped to the payment currency is selected;
(ii) else, if the payment currency corresponds to the currency supported by a subsidiary financial network, the acquiring account at the agent financial institution mapped to the payment currency is selected; or
(iii) if none of the mapped payment currencies corresponds to the payment currency, generating an error message.

17. A method of processing an electronic transfer of funds from a payer account via a financial settlement network to a payee account held at a payee financial institution in a currency that may be the same or different from funds in the payer account, which transfer occurs in response to a payment instruction transmitted by the payer to a payment gateway; said method including the steps of:
(a) providing at the payment gateway, a mapping between a plurality of payment currencies and at least one acquiring account in a currency supported by acquiring financial institutions, which acquiring financial institutions include agent financial institutions linked to subsidiary national clearing networks;
(b) providing at each acquiring financial institution, a foreign exchange bridge for determining internally any foreign exchange rates between the mapped acquiring accounts and payee accounts;
(c) the payment instruction including a payment amount, payment currency code and acquiring account details identifying the payee financial institution;
(d) the payment gateway determining whether the payee financial institution is a member of the financial settlement network, wherein:
(i) if the payee financial institution is an acquiring financial institution, the payment gateway selecting, in response to the payment instruction, an acquiring account wherein:
(A) if an acquiring account for the payee is mapped to a payment currency having the same currency as the payment currency code, that acquiring account; or
(B) if none of the mapped payment currencies for the acquiring financial institution corresponds to the payment currency code, generating an error message; else
(ii) if the payee financial institution is a member of a subsidiary national network, the payment gateway selecting in response to the payment instruction, an acquiring account wherein:
(A) if an acquiring account held at an agent financial institution for the subsidiary clearing network has the same currency as the payment currency code, that acquiring account; or
(B) if none of the mapped payment currencies for the agent financial institution corresponds to the payment currency code, generating an error message;
(e) the payment gateway creating a payment request message, including the payment amount, payment currency code and acquiring account details and passing the payment request message to the financial settlement network; and
(f) the financial settlement network routing the payment request message to the acquiring financial institution holding the acquiring account for the payee or subsidiary clearing network, wherein:
(i) if the payment currency code is for a currency not supported by the acquiring financial institution, the financial network effects the foreign exchange conversion externally of the acquiring financial institution; or
(ii) if the payment currency code is for a currency supported by the acquiring financial institution, the acquiring financial institution effects any foreign exchange conversion required via the system bridge.

18. The method of claim 17 wherein, in step (d), the payment gateway determines whether the payee financial institution is a member of the financial settlement network by checking the identifying details provided in the payment instruction.

19. The method of claim 17 wherein, the error message generated in step (d)(i)(B) indicates that the payment currency is not supported by the payee financial institution.

20. The method of claim 17 wherein, the error message generated in step (d)(ii)(B) indicates that the payment currency is not supported by the subsidiary national clearing network.
